(19) United States
(12) Patent Application Publication
(10) Pub. No.: US 2018/0338007 A1
(43) Pub. Date: Nov. 22, 2018

(54) SYSTEM AND METHOD FOR PROVIDING EXTENSIBLE COMMUNICATION GATEWAY WITH SESSION POOLING

(71) Applicant: American Megatrends, Inc., Norcross, GA (US)

(72) Inventors: Bakka Ravinder Reddy, Suwanee, GA (US); Joseprabu Inbaraj, Suwanee, GA (US); Divya Nettem, Suwanee, GA (US)

(21) Appl. No.: 15/597,517

(22) Filed: May 17, 2017

(51) Int. Cl. H04L 29/08; H04L 12/66

(52) U.S. Cl. CPC H04L 67/141; H04L 67/327; H04L 67/143; H04L 12/66

(57) ABSTRACT

Systems and methods of providing an extensible communication gateway with session pooling. The system provides multiple management applications, multiple manageabilities, and a communication gateway including a session pool. In operation, the system receives a request from one of the management applications by one of the manageabilities to establish a session to access a selected device being managed by the system. The request includes information of the selected device and the one of the manageabilities for communicating with the selected device, and data to communicate with the selected device. In response to receiving the request, the system checks the session pool of the session to be established by the communication gateway, and establishes the session by the one of the manageabilities based on a result of checking the session pool, to access the selected device.

### FIELD

The present disclosure relates generally to management of devices, and more particularly to systems and methods for providing an extensible communication gateway with session pooling, which is usable for communicating between management applications and managed devices.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A computer system normally include management applications for communicating with certain number of devices. During management of those devices, sessions need to be established between those management applications and the devices. However, the number of sessions with the devices are limited, and the establishment and the removing of the sessions are time consuming.

Therefore, an unaddressed need exists in the art to address the aforementioned deficiencies and inadequacies.

### SUMMARY

Certain aspects of the present disclosure relate to a system, which includes a computing device. The computing device includes a processor and a storage device storing computer executable code. The computer executable code, when executed at the processor, is configured to: provide a plurality of management applications, a plurality of manageabilities and a communication gateway comprising a session pool; receive a request from one of the management applications by one of the manageabilities to establish a session to access a selected device of a plurality of devices managed by the computing device, wherein the request comprises information of the selected device and the one of the manageabilities for communicating with the selected device, and data to communicate with the selected device; and in response to receiving the request: check the session pool of the session to be established by the communication gateway; and establish the session by the one of the manageabilities based on a result of checking the session pool, to access the selected device. The session pool includes active sessions that are connected with corresponding one or more of the devices and cached sessions that are disconnected from corresponding one or more of the devices.

In certain embodiments, the computer executable code is configured to establish the session to be established by: when the session pool does not have a session corresponding to the request, creating a new session corresponding to the request by corresponding one of the manageabilities, to allow communication of the data between the one of the management applications and the selected device, and updating the session pool to include the new session.

In certain embodiments, when the session pool has at least one session corresponding to the request, and the at least one session is not in use, the computer executable code is configured to establish a session by connecting the at least one session with the selected device.

In certain embodiments, the computer executable code is further configured to update the session pool by changing a status of the at least one session corresponding to the request from “not in use” to “in use”.

In certain embodiments, when the session pool has at least one session corresponding to the request, and the at least one session is in use, the computer executable code is further configured to count a number of the at least session, and compare the number with a predetermined number.

In certain embodiments, if the number of the at least one session is less than the predetermined number, the computer executable code is further configured to establish a session by creating a new session corresponding to the request to allow communication of the data between the management application and the selected device, and updating the session pool to include the new session.

In certain embodiments, if the number of the at least one session equals to the predetermined number, the computer executable code is further configured to establish a session by waiting until the at least one session changes status from “in use” to “not in use”, and connect the at least one session not in use to the selected device, and updating the session pool by changing the status of the at least one session from “not in use” to “in use”.

In certain embodiments, the predetermined number is a maximum allowable sessions under the corresponding one of the manageabilities.

In certain embodiments, the manageabilities comprises intelligent platform management interface (IPMI) protocol and secure shell (SSH) protocol.

In certain embodiments, the plurality of devices managed by the computing device comprises a baseboard management controller (BMC) and a storage device.

Certain aspects of the present disclosure relate to a method for providing an extensible communication gateway with session pooling in a management controller. In certain embodiments, the method includes: providing a plurality of management applications, a plurality of manageabilities, and a communication gateway having a session pool; receiving a request from one of the management applications by one of the manageabilities to establish a session to access a selected device of a plurality of devices managed by the computing device, wherein the request comprises information of the selected device, corresponding one of the manageabilities for communicating with the selected device, and data to communicate with the selected device; and in response to receiving the request: checking the session pool of the session to be established by the communication gateway; and establishing the session to be established by the one of the manageabilities based on a result of checking the session pool, to access the selected device. In certain embodiments, the session pool comprises active sessions that are connected with corresponding one or more of the devices and cached sessions that are disconnected from corresponding one or more of the devices.

Certain aspects of the present disclosure relate to a non-transitory computer readable medium storing computer executable code. In certain embodiments, the computer executable code, when executed at a processor of a computing device, is configured to: provide a plurality of management applications, a plurality of manageabilities and a communication gateway comprising a session pool; receive a request from one of the management applications by one of the manageabilities to establish a session to access a selected device of a plurality of devices managed by the computing device, wherein the request comprises information of the selected device, corresponding one of the manageabilities for communicating with the selected device, and data to communicate with the selected device; and in response to receiving the request: check the session pool of the session to be established by the communication gateway; and establish the session to be established by the one of the manageabilities based on a result of checking the session pool, to access the selected device, wherein the session pool comprises active sessions that are connected with corresponding one or more of the devices and cached sessions that are disconnected from corresponding one or more of the devices.

These and other aspects of the present disclosure will become apparent from following description of the preferred embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the detailed description and the accompanying drawings. These accompanying drawings illustrate one or more embodiments of the present disclosure and, together with the written description, serve to explain the principles of the present disclosure. Wherever possible, the same reference numbers are used throughout the drawings to refer to the same or like elements of an embodiment, and wherein:

FIG. 1 schematically depicts a system according to certain embodiments of the present disclosure.

FIG. 2 schematically depicts a computing device according to certain embodiments of the present disclosure.

FIG. 3 depicts a communication gateway for managing devices according to certain embodiments of the present disclosure.

FIG. 4 schematically depicts a flowchart of a method according to certain embodiments of the present disclosure.

### DETAILED DESCRIPTION

The present disclosure is more particularly described in the following examples that are intended as illustrative only since numerous modifications and variations therein will be apparent to those skilled in the art. Various embodiments of the disclosure are now described in detail. Referring to the drawings, like numbers, if any, indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present disclosure. Additionally, some terms used in this specification are more specifically defined below.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the disclosure or of any exemplified term. Likewise, the disclosure is not limited to various embodiments given in this specification.

Unless otherwise defined, all technical and scientific terms used herein have the same meaning as commonly understood by one of ordinary skill in the art to which this disclosure pertains. In the case of conflict, the present document, including definitions will control.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, “plurality” means two or more.

As used herein, the terms “comprising,” “including,” “carrying,” “having,” “containing,” “involving,” and the like are to be understood to be open-ended, i.e., to mean including but not limited to.

As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term “code”, as used herein, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The term “interface”, as used herein, generally refers to a communication tool or means at a point of interaction between components for performing data communication between the components. Generally, an interface may be applicable at the level of both hardware and software, and may be uni-directional or bi-directional interface. Examples of physical hardware interface may include electrical connectors, buses, ports, cables, terminals, and other I/O devices or components. The components in communication with the interface may be, for example, multiple components or peripheral devices of a computer system.

The terms “chip” or “computer chip”, as used herein, generally refers to a hardware electronic component, and may refer to or include a small electronic circuit unit, also known as an integrated circuit (IC), or a combination of electronic circuits or ICs.

The present disclosure relates to computer systems. As depicted in the drawings, computer components may include physical hardware components, which are shown as solid line blocks, and virtual software components, which are shown as dashed line blocks. One of ordinary skill in the art would appreciate that, unless otherwise indicated, these computer components may be implemented in, but not limited to, the forms of software, firmware or hardware components, or a combination thereof.

The apparatuses, systems and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

The present disclosure will now be described more fully hereinafter with reference to the accompanying drawings, in which embodiments of the present disclosure are shown. This disclosure may, however, be embodied in many different forms and should not be construed as limited to the embodiments set forth herein; rather, these embodiments are provided so that this disclosure will be thorough and complete, and will fully convey the scope of the present disclosure to those skilled in the art.

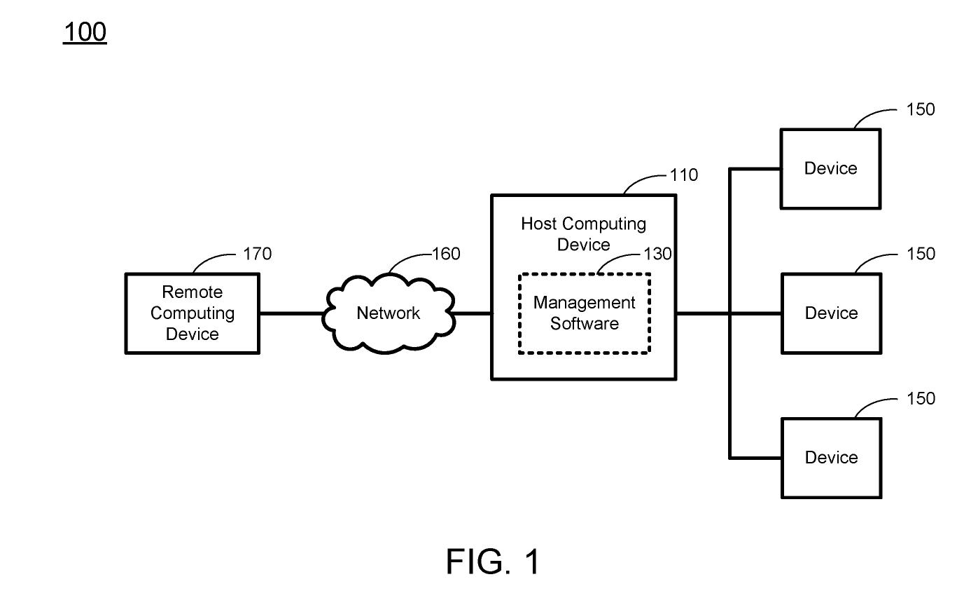

In accordance with the purposes of present disclosure, as embodied and broadly described herein, in certain aspects, the present disclosure relates to a system for providing extensible communication gateway with session polling. FIG. 1 schematically depicts a system according to certain embodiments of the present disclosure. As shown in FIG. 1, the system 100 includes a host computing device 110, a management software 130 installed on the host computing device 110, and a plurality of devices 150 managed by the management software 130. In certain embodiments, each of the devices 150 may be connected to the computing device 110 via an interface. Optionally, the system 100 may include a remote computing device 170, which is connected to the computing device 110 via a network 160. In certain embodiments, the remote computing devices 170 are clients, including thin client. In certain embodiments, the host computing device 110 may be a server. The management software 130 may manages the devices 150, and the client 170 access the devices 150 via the management software 130 located on the server 110. In certain embodiments, the network 160 may be a wired or wireless network, and may be of various forms. Examples of the network 160 may include, but is not limited to, a local area network (LAN), a wide area network (WAN) including the Internet, or any other type of networks. The best-known computer network is the Internet.

The host computing device 110 is a host computer of the management software 130. In certain embodiments, the host computing device 110 may be a general purpose computer, a specialized computer, a server, or any other types of computing device. In certain embodiments, one or more of the devices 150 may be a part of the host computing device 110. In certain embodiments, the host computing device 110 may include necessary hardware components and software components (not shown) to perform its corresponding tasks. Examples of these hardware and software components may include, but not limited to, other required memory, interfaces, buses, Input/Output (I/O) modules and peripheral devices.

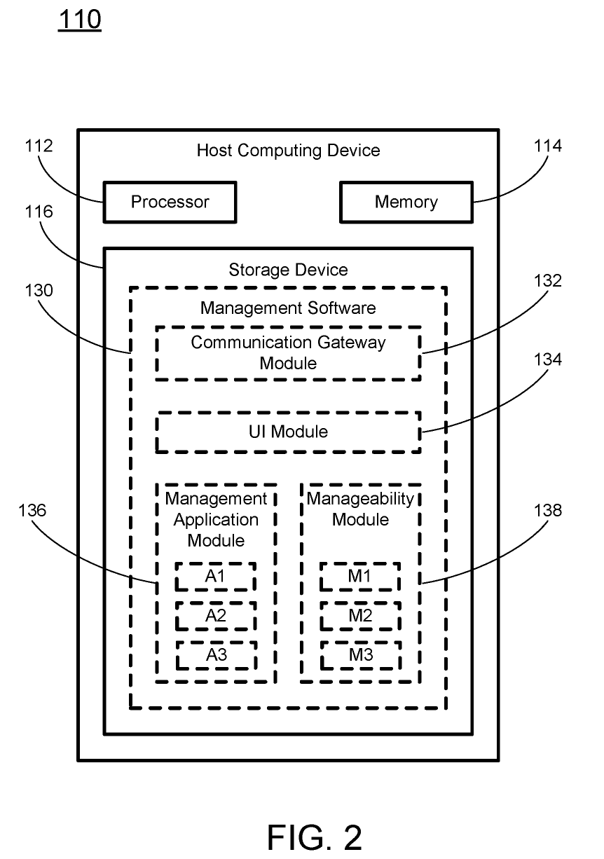

FIG. 2 schematically depicts a computing device according to certain embodiments of the present disclosure. As shown in FIG. 2, the host computing device 110 includes a processor 112, a memory 114, and a storage device 116. In certain embodiments, the computing device 110 may include other hardware components and software components (not shown) to perform its corresponding tasks. Examples of these hardware and software components may include, but not limited to, other required memory, interfaces, buses, Input/Output (I/O) modules or devices, network interfaces, and peripheral devices.

The processor 112 controls operation of the computing device 110. In certain embodiments, the processor 112 may be a central processing unit (CPU). The processor 112 may execute any computer executable code or instructions, such as the management software 130 or other codes stored in the computing device 110. In certain embodiments, the computing device 110 may run on or more than one processor, such as two processors, four processors, eight processors, or any suitable number of processors.

The memory 114 may be a volatile memory, such as the random-access memory (RAM), for storing the data and information during the operation of the computing device 110. In certain embodiments, the memory 114 may be a volatile memory array. In certain embodiments, the computing device 110 may run on more than one memory 114.

The storage device 116 is a non-volatile data storage media or device for storing the computer executable code of the computing device 110. Examples of the storage device 116 may include hard drives, floppy disks, optical drives, non-volatile memory such as flash memory, memory cards, USB drives, or any other types of data storage devices. In certain embodiments, the computing device 110 may have more than one storage device 116, and the management software 130 and other applications of the computing device 110 may be stored in the more than one storage device 116 separately.

As shown in FIG. 2, the storage device 116 stores the management software 130 of the computing device 110. The management software 130 of the computing device 110 includes computer executable codes for performing the operation of the computing device 110. In certain embodiments, the computer executable code or instructions may collectively form the management software 130. As shown in FIG. 2, the management software 130 includes, among other things, a communication gateway module 132, a user interface (UI) module 134, a management application module 136, and a manageability module 138.

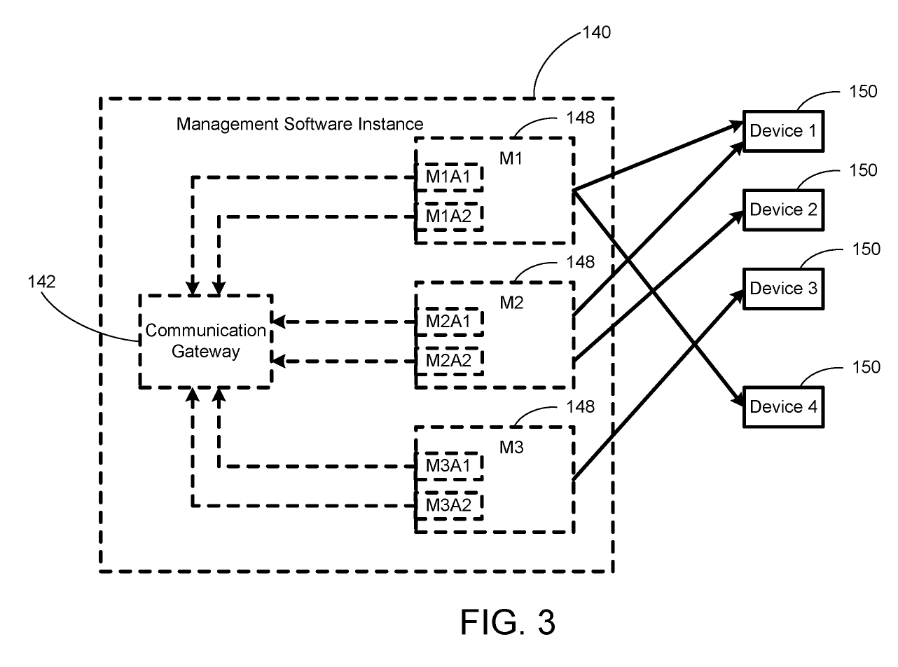

The communication gateway module 132 is a module, when executed at the processor 112, provides a communication gateway 142 as shown in FIG. 3. The communication gateway 142 manages one or more session pools for communicating the management applications with the devices 150. Specifically, the communication gateway 142 is configured to process requests from the management applications, establish sessions, cache sessions, and reuse sessions.

The UI module 134 is a module which, when executed at the processor 112, provides a UI for the communication gateway 142, such that a user or the management application may control the communication between the management applications and the devices 150 via the communication gateway 142. In other words, the management applications or the user manages operations of the sessions through the UI. Specifically, the UI is configured to provide functionalities, including establishing or create a session, caching or disconnect the established session, re-connect the cached session, set a user of a session, get device information of a session, etc. In certain embodiments, the UI may be a web UI, which is implemented and designed as a web page, such that a user may access the web UI from the host computing device 110 or the remote computing device 170 to operate sessions through the communication gateway 142.

The management application module 136, when executed at the processor 112, provides management applications. As shown in FIG. 2, the management application module 136 includes submodules A1, A2 A3, etc., which when being executed, form respectively corresponding instances of management applications A1, A2, A3, etc.

The manageability module 138 is a module which, when executed at the processor 112, provide manageabilities 148 (M1, M2, M3 . . . ) as shown in FIG. 3. The manageabilities M1, M2 and M3 is able to establish communications between the management applications A1, A2, A3 and the devices 150 using corresponding sessions. Each manageability 148 may be one type of protocol of the session. For example, the manageability M1 may be an intelligent platform management interface (IPMI) protocol, and the manageability M2 may be a secure shell (SSH) protocol.

Each of the devices 150 is a component communicatively connected to the computing device 110 such that the management applications may communicate with the devices 150 via the management instance 140. In certain embodiments, each of the devices 150 may be a hardware component, such as a hardware including power supply, memory, processor, graphic card, storage devices such as hard disk and CD-drive, or peripheral devices such as keyboard, mouse, monitor, etc. In certain embodiments, each of the devices 150 may be a virtual component simulated by software, as if the virtual device is an existing physical device. In certain embodiments, each of the devices 150 may be a local device located at the host computing device 110, and is connected to the management instance 140 via an interface. For example, some of the local devices 150 may be connected to the host computing device 110 via the system interface of the host computing device 110. In certain embodiments, some of the devices 150 may be a remote device, which is not located at the host computing device 110, and requires network connection to communicate with the host computing device 110. In certain embodiments, the system 100 may include multiple devices 150 to be managed by the management instance 140.

The remote computing device 170 is a computer communicatively connected to the computing device 110 via the network 160. In certain embodiments, the remote computing device 170 may be a general purpose computer, a specialized computer, a server, or any other types of computing device. In certain embodiments, one or more of the devices 150 may be a part of the remote computing device 170.

FIG. 3 depicts a communication gateway for managing devices according to certain embodiments of the present disclosure. As shown in FIG. 3, when the management software 130 is executed by the processor 112, a management instance 140 is provided in the memory 114. The execution of the communication gateway module 132 provides the communication gateway 142 in the instance, the execution of the management application module 136 provides applications A1, A2, A3 . . . (not shown) in the instance, the execution of the manageability module 138 provides the manageabilities 148 (M1, M2, M3 . . . ) in the instance, and the execution of the UI module 134 provides a UI (not shown) to manage the communication between the communication gateway 142 and the manageabilities 148.

Manageability is a key role that plays in supporting system robustness by facilitating many dimensions of reliability, availability and serviceability. The main functions of systems manageability can be portioned into different categories, including but not limited to: health monitoring, logging and alerting; configuration and control; deployment and updates; and asset discovery and inventory. In certain embodiments, the manageability may include host manageability, server manageability, storage manageability, and power manageability. In certain embodiments, there is a limited or a predetermined number of established sessions for one device under one manageability. In other embodiments, there is a limited number of established sessions for all the devices accessible under one manageability. In certain embodiments, there is a limited number of established sessions for all the devices accessible under different manageabilities.

As described above and shown in FIG. 3, the manageability M1 may only manage device 1 and device 2 which support communication under platform management interface (IPMI) protocol, and the manageability M2 may only manage device 1 and device 2 which support communication under secure shell (SSH) protocol. In one example, the device D1 has LINUX® operating system (OS) installed, and the M2 manageability manages or communicates with the LINUX® OS installed on device D1 under SSH protocol. In certain embodiments, a number of sessions that can be established for a device under certain manageability is a pre-determined number. For example, the manageability M1 of IPMI protocol may only allow 5 device sessions be established for device 1 and device 4. Therefore, there are at most 5 device sessions under IPMI protocol that can be established and used at the same time for device 1, and there are at most 5 device sessions under IPMI protocol that can be established and used at the same time for device 4. In certain embodiments, the 5 device sessions under IPMI protocol for device 1 may be used by the same or different management applications. For example, the 5 device sessions under M1 for device 1 may be 5 M1A1 sessions, may be 4 M1A1 sessions and 1 M1A2 session, may be 3 M1A1 sessions and 2 M1A2 sessions, may be 2 M1A1 sessions and 3 M1A2 sessions, may be 1 M1A1 session and 4 M1A2 sessions, or may be 5 M1A2 sessions. In another example, the management applications may include A1, A2, A3, A4 and A5, and the 5 device sessions under M1 for device 1 may be M1A1, M1A2, M1A3, M1A4 and M1A5. The management of device 4 under manageability M1 may be independent from the management of device 1 under manageability M1. In other words, the manageability M1 have a limit of 5 device sessions for device 1, and have a limit of 5 device sessions for device 4. Thus, the manageability M1 can hold 10 device sessions at the same time, 5 device sessions for device 1 and 5 device sessions for device 4. If a new device N is added which is manageable under manageability M1 and the device session limit is also 5 for the device N under manageability M1, then the manageability M1 can hole up to 15 device sessions, 5 for each of the devices 1, 4 and N. In other embodiments, in addition to the limit of 5 for each managed devices, the manageability M1 may also have a limit of the total number device sessions. For example, although the manageability M1 is able to support 5 device sessions for each of the devices 1, 4 and N, it also has a total limit of 12 device sessions. In this case, if the manageability M1 holds 5 device sessions for device 1 and 5 device sessions for device 4, then the manageability M1 can only support 2, not 5, device sessions for the device N.

In FIG. 3, the arrow from the manageability M1 to the device 1 may include for example 0-5 sessions, and each of the sessions is targeted to the device 1 under the manageability M1. The sessions may include 0-5 M1A1 sessions, 0-5 M1A2 sessions, . . . , or a combination thereof, as long as the total number of M1 to device 1 sessions is no more than the limit under the manageability M1 for the device 1.

In certain embodiments, the communication gateway 142 may maintain a session pool for the management software instance 140. The session pool may be maintained in a form of a session list, which includes entries of the active and cached sessions. Here the “active” sessions refers to the sessions that are “in use,” are “running,” are “activated” or “connected,” and those terms may be used interchangeably. The “cached” sessions refers to the sessions that are “not in use,” are “disconnected,” or are “inactive,” and those terms may be used interchangeably. The cached sessions include information necessary for a session, but are not connected with the corresponding device. However, the creation or establishment of a new session from scratch is different from establishment or re-connect a cached session to activate the cached session. Although both of the methods form an active session as a result, re-connect the cached session to active that cached session is simple and fast than creating a new session from scratch. In certain embodiments, the session list may include the configuration and status information of each session, including the management application using that session, the manageability of the session, the target device of that session, and status such as “in use” or “not in use” to differentiate the active session and the cached session.

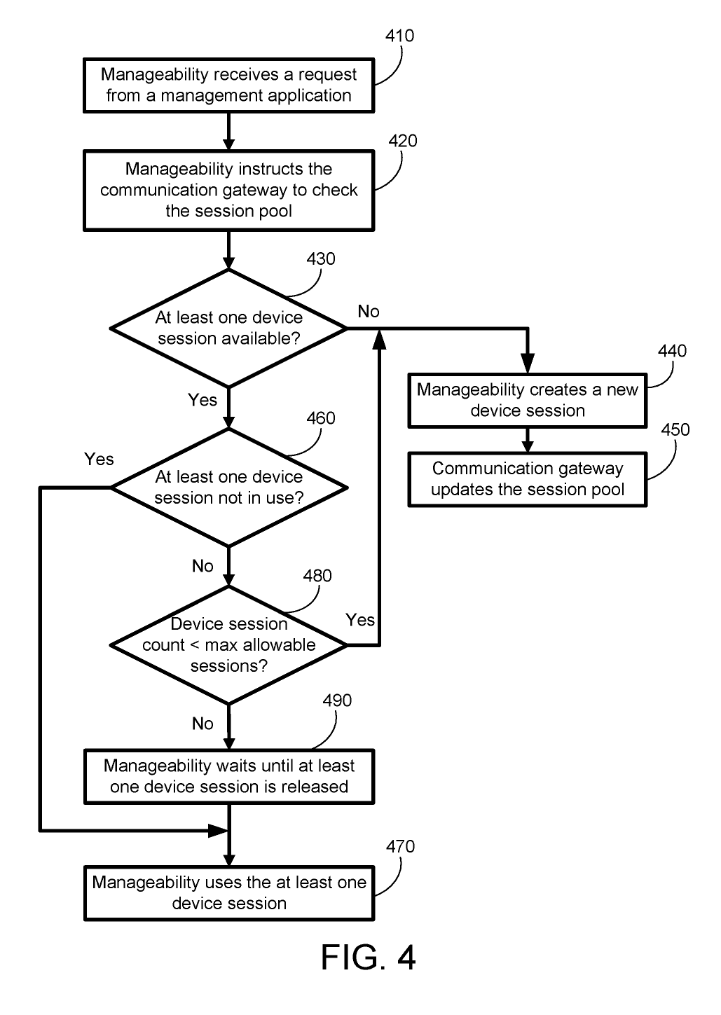

FIG. 4 schematically depicts a flowchart showing a method of providing an extensible communication gateway for managing devices according to certain embodiments of the present disclosure. In certain embodiments, the method as shown in FIG. 4 may be implemented on a system as shown in FIG. 1. It should be particularly noted that, unless otherwise stated in the present disclosure, the steps of the method may be arranged in a different sequential order, and are thus not limited to the sequential order as shown in FIG. 4.

As shown in FIG. 4, at procedure 410, one of the manageabilities 148 receives a request from one of the management applications, for communicating with one of the devices 150 managed by the management instance 140. In certain embodiments, the management application may be run on one of the host computing device 110 or the remote computing device 170. In certain embodiments, the management application may be part of the management software or may be a software independent from the management software. The request includes information for constructing a session to access the device 150, for example the target device 150, the manageability or protocol under which to access the device 150, and data to communicate with the device 150.

At procedure 420, in response to receiving the request, the manageability 148 instructs the communication gateway 142 to check the session pool.

In response to receiving the instruction from the manageability 148, at procedure 430, the communication gateway 142 checks if the session pool includes at least one device session corresponding to the request. The session pool may include a session list, the session list includes entries of the sessions that are available in the session pool. Each entry may correspond to one device session, and may include at least one of the management application, the target device, the manageability, the status of the device session (active/inactive, or in use/not in use, or in use/cached). In certain embodiments, the session list may include several entries that have the same management application, the same target device, and the same manageability, and those entries may be differentiated by an identification number, such as the first, the second, or the third of that type of device sessions. In certain embodiments, the terms “session” and “device session” may be used interchangeably to indicate a session that allows communication between a management application and the target device.

If the requested device session does not exist (not available) in the session pool, the communication gateway 142 then informs the manageability 148 of the result. In response to receiving the result that no device session is available corresponding to the request, at procedure 440, the manageability creates a new device session to communicate with or to access the corresponding device 150.

Further, after the creation of the new device session, the manageability 148 informs the communication gateway 142 of the creation of the new device session and the information of the new device session, such that at procedure 450, the communication gateway 142 in response updates the session pool to include the information of the newly created device session. In certain embodiments, the session pool includes a session list that has the information of all created sessions, and the information of the newly created device session is stored in the session list.

If the communication gateway 142 checks at procedure 430 that at least one device session is available in the session pool, then at procedure 460, the communication gateway 142 checks if the at least one of the available device sessions is not in use. In certain embodiments, the session pool may include one or more than one sessions corresponding the request, and this step is to check that among those one or more available device sessions in the session pool, if at least one of them is not in use.

If at least one of the device session in the session pool is not in use, at procedure 470, the manageability 148 can use that at least one session to access the corresponding device. In certain embodiments, the communication gateway 142 may update the session pool and label that at least one device session with the status of such as “in use,” since that at least one device session is now used by the manageability corresponding to the request. The “in use” means the session is in an “active” status and is running for the communication between the management application and the corresponding device 150. In contrast, the term “not in use” means the session is in an “inactive” status and is disconnected from the corresponding device. The session not in use or the inactive session is also called a “cached” session. In certain embodiments, if more than one of the device sessions in the session pool are not in use, the manageability may choose any one of the “not in use” sessions (or the cached session, or the inactive sessions).

If the communication gateway 142 determines at the procedure 460 that all the device sessions corresponding to the request are in use, at procedure 480, the communication gateway 142 further counts those device sessions. After the counts or the total number of the device sessions corresponding to the request is obtained, the communication gateway 142 then compares the counts with a number of maximum allowable device sessions for the device under the manageability. For example, if there is a limit of 5 device sessions for the device 1 under the manageability of IPMI protocol, then the corresponding maximum allowable device sessions is 5.

If the count is less than the maximum allowable device sessions, the method goes to the procedure 440 and 450 to create a new device session and update the session pool as described above. For example, if there are 4 sessions in the session pool that are in use to access the device 1 under IPMI protocol, and the maximum allowable IMPI sessions for device 1 under IPMI is 5, then the manageability IPMI can create a new device session to access device 1 under the IPMI protocol. The creation of the 5th device session is recorded by the communication gateway 142 to update the session pool.

If the count equals to the maximum allowable device sessions, then at procedure 490, the manageability needs to wait until a device session in the session pool is released. Here released means that a device session in use (an active session) for communicating a management application and a device is disconnected from the device since the management application does not need to communicate with the device any more. The released device session may also be termed as an inactive device session, or a session not in use, or a cached session.

Then at procedure 470, the manageability uses that released device session by re-connect the device session with the device requested by the request.

In one example, a manageability M1 receives a request from a management application A1 for communicating with the device D1. The manageability M1 instructs the communication gateway 142 to check the session pool. The communication gateway 142 finds that no device session is available in the session pool corresponding to the request. In other words, there is no device session for communicating the management application A1 with the device D1. The communication gateway 142 sends the result to the manageability M1, and the manageability M1 creates a device session M1A1 to communicate the management application A1 with the device D1. The manageability M1 may further inform the communication gateway 142 about the creation of the device session M1A1, and the communication gateway 142 updates it's session pool to record the creation of the device session M1A1. For example, the communication gateway 142 may have a session list, and the device session M1A1 is recorded as one entry in the session list.

In another example, the manageability M1 receives a request from the management application A1 for communicating with the device D1. The manageability M1 instructs the communication gateway 142 to check the session pool. The communication gateway 142 finds that a device session M1A1 is available in the session pool corresponding to the request. The communication gateway 142 also finds that the device session M1A1 is a cached session that is not in use. The communication gateway 142 sends the result to the manageability M1, and the manageability M1 uses the cached device session M1A1 by re-connecting the device session M1A1 with the device D1, so as to communicate the management application A1 with the device D1. In certain embodiments, the communication gateway 142 may updates it's session pool to change the status of that device session M1A1 from “not in use,” “inactive,” or “disconnected,” or “cached” to “in use,” or “active,” or “connected,” etc.

In a further example, the manageability M1 receives a request from the management application A1 for communicating with the device D1. The manageability M1 instructs the communication gateway 142 to check the session pool. The communication gateway 142 finds that a device session M1A1 is available in the session pool corresponding to the request. The communication gateway 142 also finds that the device session M1A1 is an active session that is in use. The communication gateway 142 further counts the number of device sessions corresponding the device D1 under the manageability M1, and finds the count is 1, which is less than the maximum allowed device sessions corresponding to the device D1 under the manageability M1. The communication gateway 142 sends the result to the manageability M1, and the manageability M1 creates a new device session M1A1, so as to communicate the management application A1 with the device D1. The manageability M1 may further inform the communication gateway 142 about the creation of the device session M1A1, and the communication gateway 142 updates it's session pool to record the creation of the device session M1A1. For example, the communication gateway 142 may have a session list, and the device session M1A1 is recorded as one entry in the session list. Thus, the session pool would have two entries of M1A1 respectively corresponding to the previous M1A1 device session and the newly created M1A1 device session.

In yet another example, the manageability M1 receives a request from the management application A1 for communicating with the device D1. The manageability M1 instructs the communication gateway 142 to check the session pool. The communication gateway 142 finds that 5 device sessions M1A1 are available in the session pool corresponding to the request. The communication gateway 142 also finds that the 5 device sessions M1A1 are all active sessions that are all in use. The communication gateway 142 further counts the number of device sessions corresponding the device D1 under the manageability M1, and finds the count is 5, which equals to (not less than) the maximum allowed device sessions corresponding to the device D1 under the manageability M1. At this time, since the maximum number of M1A1 are available and in use, the manageability M1 cannot create another new M1A1 device session due to such as system limit. Thus, the manageability M1 would wait until at least one of the 5 device sessions M1A1 is released, and then the manageability M1 would use that released M1A1 for communicating with the device D1, to meet requirement of the received request. In certain embodiments, the information of the use of the device session M1A1 is updated in the session pool.

In certain embodiments, the session pool or the session list of the session pool is located in the memory 114. Under this situation, when the computing device 110 restarts, the information stored in the memory 114 is lost. In other embodiments, the session pool or the session list of the session pool may also be stored in a data store of the storage device 116. Under this situation, even the management controller restart, the session pool or the session list of the session pool is still available in the data store.

By providing the session pool, an established session does not need to be removed or deleted completely when not in use. Instead, the established session can be cached in the management instance 140. When the session is needed next time, it is easy to reestablish the session from the cached session, because the cached session includes the configurations needed for that session.

In another aspect, the present disclosure relates to a non-transitory computer readable medium storing computer executable code. In certain embodiments, the computer executable code may be the software stored in the storage device 116 as described above. The computer executable code, when being executed, may perform one of the methods described above. In certain embodiments, the non-transitory computer readable medium may include, but not limited to, the storage device 116 of the computing device 110 as described above, or any other storage media of the computing device 110.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A system, comprising:
a computing device, comprising a processor and a storage device storing computer executable code, wherein the computer executable code, when executed at the processor, is configured to:
provide a plurality of management applications, a plurality of manageabilities and a communication gateway comprising a session pool;
receive a request from one of the management applications by one of the manageabilities to establish a session to access a selected device of a plurality of devices managed by the computing device, wherein the request comprises information of the selected device and the one of the manageabilities for communicating with the selected device, and data to communicate with the selected device; and
in response to receiving the request:
check the session pool of the session to be established by the communication gateway; and
establish the session by the one of the manageabilities based on a result of checking the session pool, to access the selected device,
wherein the session pool comprises active sessions that are connected with corresponding one or more of the devices and cached sessions that are disconnected from corresponding one or more of the devices.

2. The system of claim 1, wherein the computer executable code is configured to establish the session to be established by:
when the session pool does not have a session corresponding to the request, creating a new session corresponding to the request by corresponding one of the manageabilities, to allow communication of the data between the one of the management applications and the selected device, and updating the session pool to include the new session.

3. The system of claim 1, wherein when the session pool has at least one session corresponding to the request, and the at least one session is not in use, the computer executable code is configured to establish a session by connecting the at least one session with the selected device.

4. The system of claim 3, wherein the computer executable code is further configured to update the session pool by changing a status of the at least one session corresponding to the request from “not in use” to “in use”.

5. The system of claim 1, wherein when the session pool has at least one session corresponding to the request, and the at least one session is in use, the computer executable code is further configured to count a number of the at least session, and compare the number with a predetermined number.

6. The system of claim 5, wherein if the number of the at least one session is less than the predetermined number, the computer executable code is further configured to establish a session by creating a new session corresponding to the request to allow communication of the data between the management application and the selected device, and updating the session pool to include the new session.

7. The system of claim 5, wherein if the number of the at least one session equals to the predetermined number, the computer executable code is further configured to establish a session by waiting until the at least one session changes status from “in use” to “not in use”, and connect the at least one session not in use to the selected device, and updating the session pool by changing the status of the at least one session from “not in use” to “in use”.

8. The system of claim 5, wherein the predetermined number is a maximum allowable sessions under the corresponding one of the manageabilities.

9. The system of claim 1, wherein the manageabilities comprises intelligent platform management interface (IPMI) protocol and secure shell (SSH) protocol.

10. The system of claim 1, wherein the plurality of devices managed by the computing device comprises a baseboard management controller (BMC) and a storage device.

11. A method for providing a communication gateway in a computing device, comprising:
providing a plurality of management applications, a plurality of manageabilities, and a communication gateway having a session pool;
receiving a request from one of the management applications by one of the manageabilities to establish a session to access a selected device of a plurality of devices managed by the computing device, wherein the request comprises information of the selected device, corresponding one of the manageabilities for communicating with the selected device, and data to communicate with the selected device; and
in response to receiving the request:
checking the session pool of the session to be established by the communication gateway; and
establishing the session to be established by the one of the manageabilities based on a result of checking the session pool, to access the selected device,
wherein the session pool comprises active sessions that are connected with corresponding one or more of the devices and cached sessions that are disconnected from corresponding one or more of the devices.

12. The method of claim 11, wherein when the session pool does not have a session corresponding to the request, the step of establishing the session to be established is performed by:
creating a new session corresponding to the request to allow communication of the data between the one of the management applications and the selected device, and updating the session pool to include the new session.

13. The method of claim 11, wherein when the session pool has at least one session corresponding to the request, and the at least one session is not in use, the step of establishing the session to be established is performed by:
connecting the at least one session with the selected device; and
updating the session pool by changing a status of the at least one session corresponding to the request from “not in use” to “in use”.

14. The method of claim 11, wherein when the session pool has at least one session corresponding to the request, and the at least one session is in use, the step of establishing the session to be established is performed by:
counting a number of the at least session, and compare the number with a predetermined number, the predetermined number being a maximum allowable sessions under the corresponding one of the manageabilities;
if the number of the at least one session is less than the predetermined number, creating a new session corresponding to the request to allow communication of the data between the management application and the selected device, and updating the session pool to include the new session; and
if the number of the at least one session equals to the predetermined number, waiting until the at least one session changes status from “in use” to “not in use”, and connecting the at least one session not in use to the selected device, and updating the session pool by changing the status of the at least one session from “not in use” to “in use”,
wherein the predetermined number is a maximum allowable sessions under the manageability.

15. The method of claim 11, wherein the manageabilities comprises intelligent platform management interface (IPMI) protocol and secure shell (SSH) protocol.

16. The method of claim 11, wherein the plurality of devices managed by the computing device comprises a baseboard management controller (BMC) and a storage device.

17. A non-transitory computer readable medium storing computer executable code, wherein the computer executable code, when executed at a processor of a management controller, is configured to:
provide a plurality of management applications, a plurality of manageabilities and a communication gateway comprising a session pool;
receive a request from one of the management applications by one of the manageabilities to establish a session to access a selected device of a plurality of devices managed by the computing device, wherein the request comprises information of the selected device, corresponding one of the manageabilities for communicating with the selected device, and data to communicate with the selected device; and
in response to receiving the request:
check the session pool of the session to be established by the communication gateway; and
establish the session to be established by the one of the manageabilities based on a result of checking the session pool, to access the selected device,
wherein the session pool comprises active sessions that are connected with corresponding one or more of the devices and cached sessions that are disconnected from corresponding one or more of the devices.

18. The non-transitory computer readable medium of claim 17, wherein when the session pool does not have a session corresponding to the request, the computer executable code is configured to establish the session to be established by:
creating a new session corresponding to the request by corresponding one of the manageabilities, to allow communication of the data between the one of the management applications and the selected device, and updating the session pool to include the new session.

19. The non-transitory computer readable medium of claim 17, wherein when the session pool has at least one session corresponding to the request, and the at least one session is not in use, the computer executable code is configured to:
establish a session by connecting the at least one session with the selected device; and
update the session pool by changing a status of the at least one session corresponding to the request from “not in use” to “in use”.

20. The non-transitory computer readable medium of claim 17, wherein when the session pool has at least one session corresponding to the request, and the at least one session is in use, the computer executable code is further configured to count a number of the at least session, and compare the number with a predetermined number, wherein the predetermined number is a maximum allowable sessions under the corresponding one of the manageabilities, and wherein:
if the number of the at least one session is less than the predetermined number, the computer executable code is further configured to establish a session by creating a new session corresponding to the request to allow communication of the data between the management application and the selected device, and updating the session pool to include the new session; and
if the number of the at least one session equals to the predetermined number, the computer executable code is further configured to establish a session by waiting until the at least one session changes status from “in use” to “not in use”, and connect the at least one session not in use to the selected device, and updating the session pool by changing the status of the at least one session from “not in use” to “in use”.
